(19) United States
(12) Patent Application Publication
(10) Pub. No.: US 2005/0162684 A1
(43) Pub. Date: Jul. 28, 2005

(54) Method of controlling printing privileges

(76) Inventors: Martin J. Brown JR., Lexington, KY (US); Ryan P. Hatfield, Lexington, KY (US); Ryan W. Massengale, Lexington, KY (US); David V. Snow JR., Lexington, KY (US); Timothy G. Yorkey, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/764,157

(22) Filed: Jan. 24, 2004

(51) Int. Cl. G06K 1/00

(52) U.S. Cl. 358/1.15

(57) ABSTRACT

A method of printing includes the steps of: receiving an image data file from an originator at said printer, said image data file including at least one origination identifier; determining if said at least one originator identifier matches an authorization identifier stored in memory of said printer, said authorization identifier corresponding to at least one enable property; and printing said image data file using at least one imaging substance, said imaging substance enabled for said originator.

### BACKGROUND OF THE INVENTION

1. Field of the Invention

The present invention relates to a method of printing using a printing apparatus, and, more particularly, to a method of controlling printing privileges in a printing apparatus.

2. Description of the Related Art

Printing apparatuses or devices, such as ink jet printers, laser printers, and multi-function machines which include a printing function, now commonly include the ability to print in a monochrome mode using only a single color imaging substance (e.g., black) or a color mode using multiple color imaging substances (e.g., cyan, magenta, yellow and black). Imaging substances may be inks, toners, wax, or other substances which may be used by printing devices to apply an image data on a medium. Imaging substances may be further defined by their properties, such as their color. For example, cyan, magenta and yellow color imaging substances are primary colors which are used to form the different colors and hues required for printing a color image.

It is now also common to allow multiple users and client machines to access and print to a locally attached printing device or to a network printing device over a network, such as a local area network (LAN), wide area network (WAN), wireless network or even the internet.

At an administrative level, it may be desirable to limit which of these users or machines can use the replaceable supply items or consumables (e.g., color imaging substances, staples or media) associated with the printing device. Allowing use of certain consumables only to specific or authorized users can extend the life of such consumables. For example, limiting the use of color printing may extend the life color imaging substances.

Attempts have been made to limit color printing to specific users, but with only limited success. For example, U.S. Pat. No. 6,202,092 (Takimoto) discloses a printing system which limits the printing features which a particular user may use. The printer or the server machine may include software which is used to identify which printing features a user is allowed access to. However, the control file containing the profile data for each user is always stored on the server side of the network so that the printer must be coupled to the server for the printer to operate with this functionality. It may be desirable to couple the printing device or printer with a different server or a different network, in which case the control file containing the user information must be entirely regenerated.

What is needed in the art is an improved method of printing which controls use of consumables for the print devices.

### SUMMARY OF THE INVENTION

The present invention provides a method of printing which controls printing privileges by allowing only certain originators of image data files to use imaging substances in a printer.

The invention comprises, in one form thereof, a method of printing including the steps of: receiving an image data file from an originator at said printer, said image data file including at least one origination identifier; determining if said at least one originator data matches an authorization identifier stored in memory of said printer, said authorization identifier corresponding to at least one enable property; and printing said image data file using at least one imaging substance, said imaging substance enabled for said originator.

An advantage of the present invention is that color printing privileges can be extended to only authorized users, based on a user ID, group ID, client computer or machine ID or other identifying information.

Another advantage is that the amount of imaging substances for color printing can be reduced.

Yet another advantage is that the memory which stores the data file for the color enable ability of each originator is located in the printer rather than at another network location such as a server or client machine or in a locally attached personal computer.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic illustration of an embodiment of a network printing system which may be used for carrying out the method of the present invention; and

FIG. 2 is an embodiment of a flow chart illustrating the method of printing of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

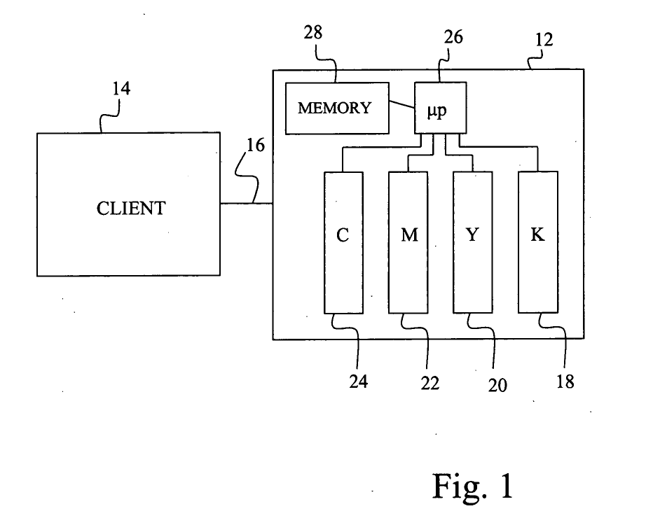

Referring now to the drawings, and particularly to FIG. 1, there is shown an embodiment of a network printing system 10 of the present invention, with which the method of printing of the present invention may be utilized. Network printing system 10 generally includes a printer, printing apparatus or printing device 12 which is coupled with a client computer 14 via a network 16. Other client computers and a server may also be connected with network 16. Network 16 may be any suitable type of network, such as a local area network (LAN), wide area network (WAN), wireless network or internet. Printer 12 is shown as a network printer which is directly coupled with network 16, but may also be indirectly coupled with network 16 via a host computer or the like.

Printer 12 may be any printing apparatus device, such as a printer in the form of an ink jet printer or laser printer. Printer 12 may also be a multi-function machine which incorporates a printing function. In this embodiment, printer 12 is a color laser printer configured to accept a monochrome imaging substance and one or more color imaging substances. In the embodiment shown, there is one monochrome imaging substance 18 and three color imaging substances 20, 22 and 24 housed in separate containers. Monochrome imaging substance 18 is black (K) toner; color imaging substance 20 is yellow (Y) toner; imaging substance 22 is magenta (M) toner; and imaging substance 24 is cyan (C) toner. Depending upon the configuration of the printer 12, imaging substances may be housed in multiple containers, or each may be housed in a portion or chamber of a single container.

Monochrome imaging substance 18 and color imaging substances 20, 22 and 24 are each coupled with an electrical processing circuit in the form of a microprocessor 26. Microprocessor 26 is coupled with a memory 28, which in one embodiment is in the form of a flash memory. Memory 28 may also be another suitable type of memory, preferably non-volatile and read/write, such as a hard drive, etc.

Memory 28 is used at least in part to store authorization data or records in any suitable format, such as a lookup table or linked list. Such authorization data may include a plurality of authorization identifiers corresponding to a plurality of authorized users At least one enable property is also stored in memory 28 for each authorization identifier contained therein. The enable property generally indicates whether the authorized user is allowed to use all of the imaging substances 18, 20, 22 and 24 within printer 12, or is only allowed to use a subset of the imaging substances 18-24. More particularly, in one embodiment, the enable property is a boolean expression either enabling or disabling the ability the printer 12 to print the image data file using color imaging substances 20, 22 and 24, thereby limiting imaging substances use.

The authorization identifier for each authorized user which is stored in memory 28 may correspond to the identity of a user operating client machine 14 (user ID), the identity of a user classified in a particular group operating client machine 14 (group ID), or to the identification of the client machine itself (computer ID) regardless of who is using the computer or some other identity.

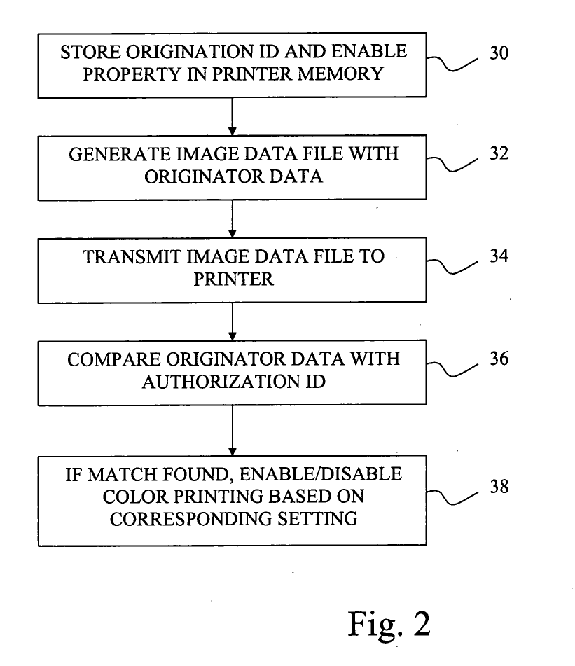

To utilize the method of printing of the present invention which limits color printing to specific originators, it is necessary that the authorization identifiers and corresponding enable properties be stored in printer memory 28 prior to receiving the image data file (FIG. 2; block 30). Such authorization data may be preset by the manufacturer. Such authorization data may also be set at the administrative level. A default which may determine which imaging substances are available for use if the origination identifier received from the image data file does not match any authorization identifier stored in the memory may also be stored.

One embodiment of the method of printing using the present invention is described below. Client machine 14 generates an image data file, such as through a word processing software application, scanner, fax, etc. (block 32). The image data file may be in any format suitable for printing and may contain text only, text and pictures, etc. The image data file may also include originator data corresponding to the originator (i.e., sender) which requests transmission of the image data file. Originator data may include the user ID, group ID, computer ID or some other identification. The image data file, including the originator data, is transmitted over network 16 to printer 12 (block 34). Microprocessor 26 extracts the originator data from the image data file and compares the originator data with the authorization identifiers stored in memory 28 (block 36). If the originator data matches an authorization identifier, the enable property(ies) corresponding to the authorization identifier may then be used to enable or disable operation of the corresponding color imaging substances 20, 22 and 24 during printing of the image data file with printer 12 (block 38), thereby limiting imaging substance use to specific authorized users.

Further, it is also possible to override the enable properties stored in the lookup table with an override property for a specific computer attached to the printer. For example, it may be desirable to disable color printing or disable printing entirely for anyone using a specific computer attached to a network, or a computer attached directly to a printer (such as a non-network or pier-to-pier network application).

While the embodiment shown in FIG. 1 depicts a network printing system, printer 12 may be a locally attached printing device in other embodiments. In yet other alternative embodiments, personal computers, personal digital assistants or other suitable devices may generate the image data files.

Moreover, it is possible to extend the same methodology of the present invention to control use of other deplenishable supplies or other replacement supply items or consumables other than imaging substances. For example, it may be desirable to limit use of a stapler, particular types of media (e.g., transparencies), etc. This methodology may be even further extended to limiting the performance of certain printing functions, such as multiple copy printing or confidential printing, to authorized users.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of printing an image data file on a printing device, comprising the steps of:
receiving an image data file from an originator at said printer, said image data file including at least one originator identifier;
determining if said at least one originator identifier matches an authorization identifier stored in memory of said printer, said authorization identifier corresponding to at least one enable property; and
printing said image data file using at least one imaging substance, said imaging substance enabled for said originator.

2. The method of printing of claim 1, wherein said enable property either enables or disables operation of said imaging substance for said image data file.

3. The method of printing of claim 1, wherein said imaging substances include cyan toner, magenta toner and yellow toner.

4. The method of printing of claim 1, wherein said imaging substances include cyan ink, magenta ink and yellow ink.

5. The method of printing of claim 1, wherein said imaging substances are waxes.

6. The method of printing of claim 1, wherein said memory is a non-volatile memory.

7. The method of printing of claim 1, wherein said authorization identifiers and said at least one enable property are stored in a look-up table.

8. The method of printing of claim 1, wherein said memory is a flash memory.

9. The method of printing of claim 1, wherein said originator identifier includes at least one of a user identifier and computer identifier.

10. The method of printing of claim 1, wherein said receiving is received from over a network.

11. A method of printing using a printer capable of printing image data and having a plurality of imaging substances comprising the steps of:
receiving at said printer an image data file, said image data file including image data and data corresponding to an originator of said image data file;
comparing said originator data with authorization data stored in memory of said printer, said authorization data including at least one authorization identifier and at least one enable property for each authorization identifier; and
printing said data using at least one imaging substance, said imaging substance enabled for said originator.

12. The method of printing of claim 11, further comprising enabling or disabling use of said imaging substances for said image data file based upon said authorization data, provided said originator data matches at least one authorization identifier.

13. The method of printing of claim 11, wherein said imaging substances include a cyan toner, magenta toner and yellow toner.

14. The method of printing of claim 11, wherein said memory is a non-volatile memory.

15. The method of printing of claim 11, wherein said authorization data stored in memory is stored in a look-up table.

16. The method of printing of claim 11, wherein said memory is a flash memory.

17. The method of printing of claim 11, wherein said origination identifier includes at least one of a user identifier and computer identifier.

18. The method of printing of claim 11, wherein said receiving is received from a client computer over a network.

19. A method of using a print device on a print medium, comprising the steps of:
receiving at said printer an image data file from an originator, said image data file including at least one origination identifier;
comparing said at least one origination identifier with authorization data stored in memory of said printer, said authorization data including at least one authorization identifier corresponding to at least one enable property for a consumable; and
performing an operation requiring said consumable provided said consumable is enabled for said originator.

20. The method of claim 19, wherein said consumable comprises one of toner, ink, staples and media type.

21. The method of claim 19, further comprising the steps of:
overriding at least one said enable property stored in said memory; and
operating said printer with an availability of said consumable corresponding to said override.

22. A method of using a print device, comprising the steps of:
receiving a function request from an originator, said request including at least one origination identifier;
comparing said at least one origination identifier with authorization data stored in memory of said printer, said authorization data including at least one authorization identifier corresponding to at least one enable property for a function; and
performing said function, provided said function is enabled for said originator.
